(19) United States
(12) Patent Application Publication
(10) Pub. No.: US 2009/0304983 A1
(43) Pub. Date: Dec. 10, 2009

(54) Non-Wettable Surfaces

(76) Inventors: Wilhelm Barthlott, Bonn (DE); Zdenek Cerman, Bonn (DE); Andreas Scherrieble, Ludwigsburg (DE); Thomas Stegmaier, Owen (DE); Boris Striffler, Zuelpich (DE); Volkmar Von Arnim, Kircheim Unterteck (DE)

Correspondence Address: OHLANDT, GREELEY, RUGGIERO & PERLE, LLP, ONE LANDMARK SQUARE, 10TH FLOOR, STAMFORD, CT, 06901, US

(21) Appl. No.: 12/224,578

(22) PCT Filed: Mar. 1, 2007
(86) PCT No.: PCT/EP2007/051938

§ 371 Date: Mar. 5, 2009

(30) Foreign Application Priority Data
Mar. 1, 2006 (DE) 10 2006 009761.0

(51) Int. Cl. D06M 10/00; B29C 59/02; C08J 5/18; D06M 23/00

(52) U.S. Cl. 428/92; 264/220

(57) ABSTRACT

An object having a surface that has:
filaments having a length of from 30 to 6000 μm, a diameter to length ratio of from 1:10 to 1:20, and are bound to the surface with at least one front face thereof;
wherein the distance between two neighboring filaments on the surface is such that the ratio of such distance to the length of the filaments is from 1:3 to 1:10;
the filaments have an elasticity of from 10⁴ to 10¹⁰ N/m²;
the surface of the filament is hydrophobic, so that the contact angle between a filament and water is greater than 100°.

### BACKGROUND

1. Field of the Disclosure

The present disclosure relates to unwettable surfaces, processes for the preparation thereof, and the use thereof.

2. Discussion of the Background Art

WO 96/04123 relates to self-cleaning surfaces of objects having elevations of hydrophobized material. Contaminations deposited on such surfaces can be removed by moving water.

Such surfaces are interesting in fields of application where surfaces are in contact with contaminations, for example, from the air, and can be cleaned by occasional contact with water, for example, rain. As found in studies, such surfaces have contact angles with water of above 130°. The drops, which adopt a spherical shape, are not capable of wetting the surface.

US 2005/0061221 describes the problem of reducing the frictional resistance in a relative motion between a solid surface and a liquid. A hierarchic fractal structure is described for that purpose. Examples are not described.

WO 2005/005679 relates to nanofibers and structures comprising nanofibers, and the use thereof.

Nevertheless, there remains a desire for surfaces that are unwettable by water, i.e., are not wet after being contacted with water. Such surfaces are able to reduce the frictional resistance between water and the surface and also have other properties that are desirable from a technological point of view, such as thermal insulation or avoiding of biofouling.

It is the object of the disclosure to provide such surfaces.

This object is achieved by an object having a surface with the following characteristics:
filaments having a length of from 30 to 6000 μm, a diameter to length ratio of from 1:10 to 1:20, and are bound to the surface with at least one front face thereof;
wherein the distance between two neighboring filaments on the surface is such that the ratio of such distance to the length of the filaments is from 1:3 to 1:10;
the filaments have an elasticity of from 10⁴ to 10¹⁰ N/m²;
the surface of the filament is hydrophobic, so that the contact angle between a filament and water is greater than 100°.

Thus, according to the disclosure, an object having a surface is provided.

### SUMMARY

A filament within the meaning of the present application is any elongate structure made of any material that has the required properties. In the textile field, a distinction is made between protruding hairs, protruding fibers and filaments having a very great length. Within the meaning of the present application, however, the term “filament” is used for any kind of structure that has ends. Its length and diameter can be seen from the further definition in the claims. For this application, the word “filament” is interchangeable with the terms “fiber” or “hair” as used in the textile field. A filament within the meaning of the present application is also a lengthy structure bound to a surface at two or more points. In this case, the region between two contact points defines the length of the filament within the meaning of the present application.

When a filament as understood by the textile industry, i.e., structures consisting of long fibers whose length is limited only by the winding capacity of a bobbin, is referred to in this application text, the term “textile filament” is used. Such textile filaments have a length of many meters.

At the surface according to the disclosure, there are filaments having a length that is greater than their diameter. The diameter to length ratio (diameter:length) is from 1:10 to 1:20, preferably from 1:12 to 1:18. Suitable lengths are within a range of from 30 to 6000 μm, preferably from 50 to 1000 μm, more preferably from 50 to 200 μm, such as from 1000 to 3000 μm.

If structures are bound to the surface at several contact points, they also form filaments having a corresponding length if the appropriate distances exist between two contact points, i.e., the length of the structures between two contact points is measured; this length is defined as the length of the filament.

The filaments have two front faces situated at either end of the filaments.

### BRIEF DESCRIPTION OF THE DRAWINGS

FIG. 1 illustratively shows filaments on a surface.

FIG. 2 shows the magnification II of a filament with structures. The filaments in turn have filamentous structures.

FIG. 3 shows the magnification III of a filament with structures. The filaments have particles on their surface.

FIG. 4 shows the magnification IV of a filament with structures. The filaments have grooves that function to leave the non-grooved areas as elevations.

FIG. 5 shows a scanning electron micrograph of a textile made of shrinkable and extendable textile filaments. 1 cm in the micrograph corresponds to 120 μm.

FIG. 6 shows a textile filament with several contact points on the surface. The length of the filaments according to the disclosure is defined as the length of textile filament between two contact points.

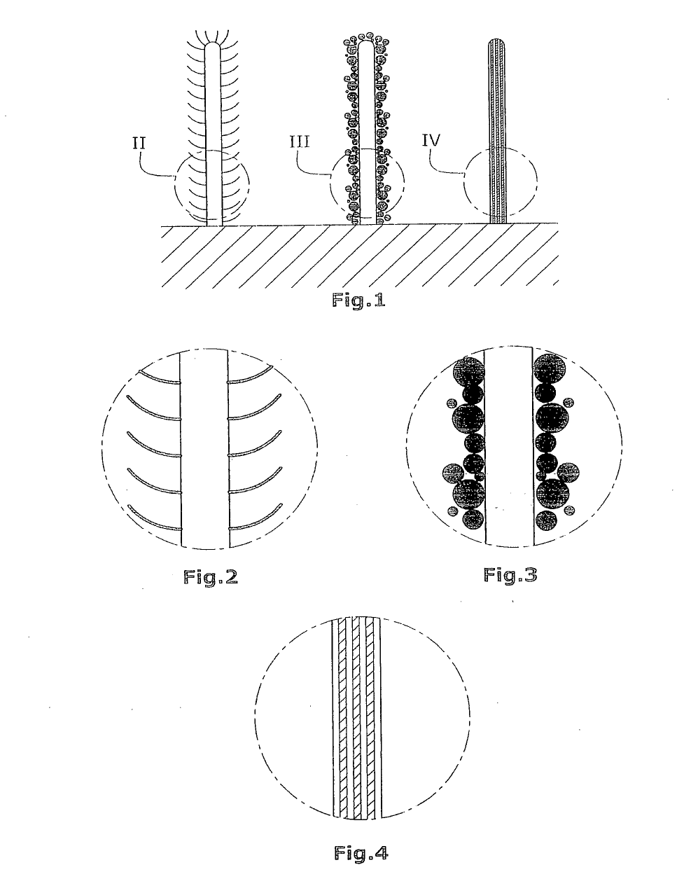

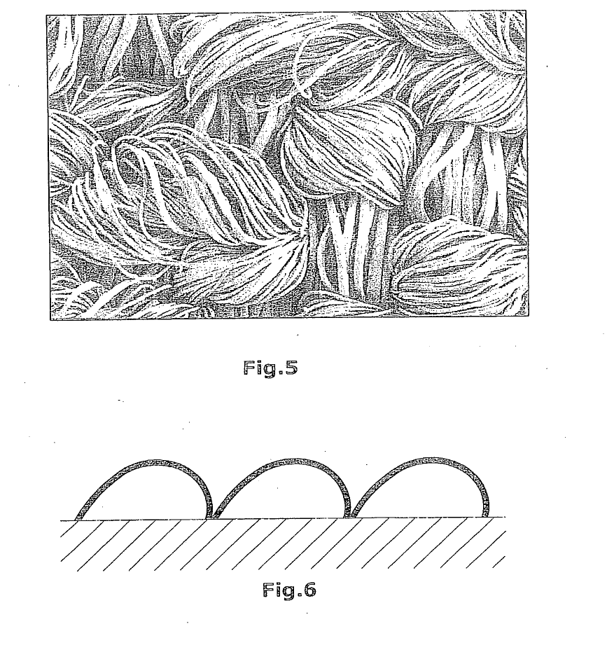

### DETAILED DESCRIPTION OF THE PREFERRED EMBODIMENT

In one embodiment, exactly one front face is bound to the surface. In another embodiment, both front faces are bound, so that the filament forms a loop on the surface. Mixed forms in which both filaments bound with one front face and filaments bound with two front faces occur are also possible.

The diameters of filaments can be measured, for example, by scanning electron microscopy.

If the fibers have diameters that vary over the length of the fiber, the diameter in the middle of the filament (at 50% of the length) is used.

The filaments are on the surface in a mutual distance, wherein the ratio of the distance to the length of neighboring filaments (distance:length) is from 1:3 to 1:10, i.e., for a filament having a length of 6000 μm, a neighboring filament is at a distance within a range of from 2000 to 600 μm.

In one embodiment, the ratio may also be within a range of from 1:3 to 1:30.

The elasticity of the filaments is important to the surface according to the disclosure. The elasticity as determined by the modulus of elasticity is within a range of from 10⁴ to 10¹⁰ N/m². The elasticity allows a longitudinal elastic elongation of the filaments. Preferred ranges are from 10⁶ to 10⁸ N/m². Preferably, the flexural modulus of elasticity is also within this range.

Further, the surface of the filament must be hydrophobic, so that the contact angle between a filament and water is greater than 100°. This can be measured, for example, with an inverted microscope and ultrasonic atomization as described in Suter et al., Journal of Arachnology, 32 (2004), pages 11 to 21. Preferably, the contact angle is greater than 110°.

In another embodiment, the hydrophobicity can also be measured macroscopically. Materials according to the disclosure preferably have macroscopic contact angles of greater than 140°.

Surprisingly, such surfaces according to the disclosure are able to entrap air within the structures in a way that it is not displaced by water; thus, the surfaces are unwettable. In particular, the elasticity of the filaments is important, since this allows to retain the air even in currents. Movements of the water can be absorbed elastically by the filaments.

In one embodiment, the filament itself has a structure comprising elevations with a height of from 20 nanometers to 10 μm. Preferably, the elevations are smaller than 10% of the diameter of the filament.

Preferred embodiments of the present disclosure are unwetted upon contacting with water. “Unwetted” means that when the surface is completely submerged in water at a depth of 15 cm for 48 hours, at least 97% of the surface is found to be dry in a macroscopic test upon emerging of the object.

The disclosure also relates to a process for preparing such objects, comprising the steps of:

preparing a surface with the filaments in such a way that:
it has filaments having a length of from 30 to 6000 μm, a diameter to length ratio of from 1:10 to 1:20, and are bound to the surface with at least one front face thereof;
wherein the distance between two neighboring filaments on the surface is such that the ratio of such distance to the length of the filaments is from 1:3 to 1:10;
the filaments have an elasticity of from 10⁴ to 10¹⁰ N/m²;
the surface of the filament is hydrophobic, so that the contact angle between a filament and water is greater than 100°.

For the preparation of such surfaces, textiles or textile production methods are particularly suitable.

Suitable surfaces can be obtained by textiles in which textile filaments shrinking in a thermosetting process “shrinkable filaments”) are combined with textile filaments that do not, or hardly, change in length during the thermosetting process. It is also possible to combine shrinkable textile filaments with textile filaments that become elongated in the thermosetting process. “Thermosetting process” herein means a treatment at 150° C. for 5 minutes. In the textile field, other conditions for thermosetting are also employed.

Textiles prepared therefrom will contract a little due to the shrinking yarns, while the yarns that do not, or hardly, change in length or the expanding yarns form loops or bows on the surface.

It is also possible to use pretensioned spandex filaments, wherein a formation of loops or bows in the coprocessed synthetic fiber (staple fiber or multi- or mono-filament) is effected upon relaxation.

It is also possible to use mechanically swirled yarns that are subsequently treated thermally for setting (for example, textured yarns, bulk yarns, high-bulk yarns), optionally in combination with a yarn intermingling process.

Also suitable are twisted yarns (loop yarn), chenille or chenille loop yarn, core spun yarn, twisted thread made from yarns of different materials, bicomponent yarns in which the sheath has an elongation behavior in the thermal setting process, or in which the core has a higher shrinking performance than that of the sheath to form a hollow space between the core and sheath available for air entrapment.

In principle, woven fabrics, knitted fabrics, non-woven fabrics, braids, flocked surfaces are suitable, including, in particular, double-knit fabrics, such as spaced woven fabrics and spaced knitted fabrics.

It is also possible to achieve loops by a terry cloth fabric based on a woven or knitted fabric. After a thermal setting process, the loops may also be cut to obtain filaments bound on one side.

Further suitable materials are pile fabrics, such as velvet or plush or warp or weft in smooth (velvet) or ribbed (cord) designs, imitation plush and pelt based on knitted fabrics, tufted fabrics. Protruding fibers can also be realized on a base fabric that already has yarn loops.

Also, an adhesive may first be applied by a flocking technique by means of printing methods, such as screen printing, and then flock fibers are applied thereto. Loops may also be pulled out of a base fabric by a raising treatment.

In one embodiment of the disclosure, spaced textiles are employed. These include a space between two layers. This space can be utilized for supplying air. In particular, it is possible that air exits from the intermediate space through the upper layer and thus provides for new air cushions. This could be supported by a slightly increased pressure between the layers.

Usually, the hydrophobicity of the corresponding materials is not sufficient, so that hydrophobization must be effected subsequently. Materials suitable for this purpose include materials with which hydrophobic coatings can be achieved in the textile field, for example, those based on fluorocarbons, waxy substances, silicone-based substances etc.

The objects according to the disclosure may be used, for example, for preparing bathing wear that remains dry. In the field of swimming wear for swimming competitions, this could additionally contribute to a reduction of the flow resistance. It is also possible to achieve an increased pressure between two layers of a spaced textile by the design of the swimming suit.

The material is further suitable for preparing diving suits and suits for surfers and wind surfers; especially with divers, the compressed air, which is available anyway, could be used to obtain an increased pressure between two layers of the spaced textile.

In addition to the clothing field, the materials according to the disclosure are also suitable for the cladding of tubes to reduce the flow resistance. Also, it is possible to employ such surfaces at bodies of ships. Especially together with measures for renewing the air layers, the flow resistance can be thus reduced.

Another possibility of preparing such structures are so-called micro-replica processes. In such processes, the surface of a material that has appropriate properties is converted to a negative by means of a casting compound. This negative form may then be used to prepare corresponding surfaces by means of a liquid plastic material, for example, a synthetic resin lacquer.

In a particular preferred embodiment, several forms are used in order that surfaces with greater surface areas can be obtained.

A process in which the negative forms are assembled to a roll is particularly suitable. In this way, the preparation may be effected continuously by passing a curable plastic composition through the roll nip. Directly after the forming, the synthetic resin composition is cured by irradiation, for example, ultraviolet irradiation, and then remains in the surface structure as defined by the form.

The disclosure is further illustrated by the following Examples.

### EXAMPLE 1

A multifilament yarn consisting of polyester fibers made of an extendable component and a shrinkable component was woven in plain weave. Subsequently, a thermal treatment was performed, leading to loop formation. This was followed by a coating of the fabric. The coating consisted of a fluorocarbon-containing compound in combination with nanoparticles based on Al₂O₃ or SiO₂.

An aqueous formulation of these components was used to soak the fabric therein. Excess material was removed by a squeezing mangle. This was followed by a drying step at about 150° C. An application weight per unit area of from 0.1 to 3.0% by weight was achieved thereby, depending on the concentration of the coating agent. After the drying, the corresponding textiles showed that they remained virtually unwetted upon submerging in water (depth 15 cm) for 48 hours. Upon emerging of the object, no wetting of the material could be observed macroscopically.

### EXAMPLE 2

Micro-replica process

Two-component silicone casting compound (e.g., President Light Body, Coltène, Switzerland) is applied to the surface of water fern (Salvinia natans) or water lettuce (Pistia stratiotes). After curing, the flexible and rubber-like negative is peeled off. The negative is cut to a rectangle, and this process is repeated several times. Subsequently, the negatives are placed in succession in a form to achieve a greater surface area. In order to achieve seamless transitions, a slight pressure is applied to the negatives from all sides. Acrylic lacquer is poured into the thus prepared negative form for casting. If a polymer with high hydrophobicity is used, a further hydrophobization of the replica is not necessary, otherwise the replica must be hydrophobized afterwards, for example, with Antispread F 2/50 FK 60 (Dr. Tilwich, Horb, Germany).

### EXAMPLE 3

Several negative forms as obtained in Example 2 were assembled to a roll. A UV-curable lacquer was fed onto the roll throughout the width thereof and structured by means of the thus prepared roll. Immediately after the contact between the roll and film, curing of the lacquer was effected by means of a UV lamp. In this way, a sheet was obtained that had the surface structure according to the disclosure.

### EXAMPLE 4

Combined photolithography/etching process

Preparation of a surface made of PDMS (polydimethylsiloxane):

In a silicone surface (e.g., PDMS), perforations are punched into a positive lift-off photoresist at a mutual distance of from 3 to 10 μm by means of a mask aligner.

After gold sputtering, the photoresist is peeled off, and the remaining gold platelets function as a mask. The latter protect the underlying silicone layer from the subsequently performed plasma etching (reactive ion etching), whereby the filaments are etched from the silicone. When the hydrophobicity is not sufficient, a later hydrophobization is necessary, for example, with Antispread F 2/50 FK 60 (Dr. Tilwich, Horb, Germany).

1. An object having a surface that has:
filaments having a length of from 30 to 6000 μm, a diameter to length ratio of from 1:10 to 1:20, and are bound to the surface with at least one front face thereof;
wherein the distance between two neighboring filaments on the surface is such that the ratio of such distance to the length of the filaments is from 1:3 to 1:10;
the filaments have an elasticity of from 10⁴ to 10¹⁰ N/m²;
the surface of the filament is hydrophobic, so that the contact angle between a filament and water is greater than 100°.

2. The object according to claim 1, wherein said filament is provided with a structure comprising elevations with a height of from 20 nanometers to 10 μm.

3. The object according to claim 1, wherein said object remains unwetted upon contacting with water for at least 48 hours.

4. The object according to claim 1, wherein said filaments are bound to the surface with both front faces thereof.

5. The object according to claim 1, wherein said object having a surface is a textile.

6. The object according to claim 5, wherein said textile consists of shrinkable and non-shrinkable or extendable textile filaments.

7. The object according to a of claims 1, wherein said object is a polymer sheet.

8. A process for preparing an object according to claim 1, comprising the steps of:
preparing a surface with the filaments in such a way that:
it has filaments having a length of from 30 to 6000 μm, a diameter to length ratio of from 1:10 to 1:20, and are bound to the surface with at least one front face thereof;
wherein the distance between two neighboring filaments on the surface is such that the ratio of such distance to the length of the filaments is from 1:3 to 1:10;.
the filaments have an elasticity of from 10⁴ to 10¹⁰ N/M²;
the surface of the filament is hydrophobic, so that the contact angle between a filament and water is greater than 100°.

9. The process according to claim 8, wherein shrinkable and non-shrinkable or extendable textile filaments are employed for said preparation.

10. The process according to claim 8, wherein a micro-replica process is employed.

11. Use of the object according to claim 1 for achieving unwettability of said object.
